(19) United States
(12) Patent Application Publication
(10) Pub. No.: US 2009/0162478 A1
(43) Pub. Date: Jun. 25, 2009

(54) HIGH MELT LIPIDS

(76) Inventors: Dylon Abend, Whippany, NJ (US); Richard Robert Tenore, Sparta, NJ (US)

Correspondence Address: STEPAN COMPANY;c/o MCANDREWS HELD & MALLOY, 500 WEST MADISON, 34TH FLOOR, CHICAGO, IL, 60661, US

(21) Appl. No.: 11/997,504

(22) PCT Filed: Aug. 14, 2006
(86) PCT No.: PCT/US06/31650

§ 371 Date: Jul. 23, 2008

Related U.S. Application Data
(60) Provisional application No. 60/708,168, filed on Aug. 15, 2005.

(51) Int. Cl. C11C 3/04; A23D 7/00; A23L 1/22; A23L 1/30; A23L 1/302; A23L 1/304; A23L 1/303

(52) U.S. Cl. 426/33; 426/601; 426/89; 426/92; 426/72; 426/61; 426/73

(57) ABSTRACT

The presently described technology relates to edible fatty acid ester compositions and methods of preparing the same. The described edible fatty acid ester compositions are prepared by blending a source of fatty acid or fatty acid ester with a polyhydroxy polyol and reacting the components under appropriate conditions to produce an ester or polyester of the polyhydroxy polyol with a melting point of the final composition of greater than about 65° C. The described edible fatty acid esters may be used, for example, to avoid release of a functional ingredient within a food product until temperatures exceed about 65° C.

### FIELD OF THE INVENTION

The technology of the present technology generally relates to edible fatty acid ester compositions prepared by blending a source of fatty acid or fatty acid ester with a polyhydroxy polyol and reacting the two components under appropriate conditions to produce an ester or polyester of the polyhydroxy polyol with a melting point for the final composition of greater than about 65° C. Edible fatty acid ester compositions of the present technology can be used in encapsulation of components for applications in which it is desired that the encapsulated component not be released until the encapsulation shell dissolves or melts. Such applications include, but are not limited to, fluid bed encapsulation shell materials, emulsifiers for food products, and personal care emulsifiers.

### BACKGROUND OF THE INVENTION

Food ingredients, such as flavors or leavening agents, can be lost in high temperature applications, such as baking, when exposed to high temperatures for prolonged periods of time. One of the preferred methods to control retention and release of such ingredients is encapsulation. In order to allow the food to better capture the flavor or leavening agent, an encapsulated component is preferably not released until the encapsulation shell dissolves or melts.

One type of encapsulation that is used for food products consists of water-soluble particles containing, for example, a dispersion of flavor oil. A number of water-soluble carrier materials are used in this type of encapsulation, including sugars, modified starches and gums. Spray drying, extrusion and fluidized bed coating are common methods of producing such encapsulated particles. Encapsulation in a water-soluble matrix is most suitable for controlling ingredient delivery in dry products. However, this type of encapsulation is unsuitable for ingredient release in products that contain water because the shell dissolves upon contact with water, thereby releasing the ingredient contained within.

Another encapsulation method involves using particles that are water-insoluble and heat-stable. One common preparation method for such particles is encapsulation by coacervation. Coacervation encapsulates usually release their core material when exposed to mechanical abrasion, such as shear in the mixing process, and are designed to protect sensitive material up until the time of use. U.S. Pat. No. 6,325,859, issued on Dec. 4, 2001 to De Roos, et al., the disclosure of which is hereby incorporated by reference, is directed to a coacervation process. In the process disclosed by U.S. Pat. No. 6,325,859, beads are prepared containing at least one active ingredient, such as a flavor, fragrance, vitamin, and/or coloring material for food or tobacco products, where the active ingredient is released at a controlled rate. In preparing the beads of process as disclosed in U.S. Pat. No. 6,325,859, discrete droplets of the active ingredient and an acid polysaccharide are formed in an aqueous medium, then the droplets are converted to water insoluble gel beads by introducing the droplets into a solution containing multivalent cations, thereby building a suspension of gel beads. The process disclosed in U.S. Pat. No. 6,325,859 is intended to release the component of the core in the mixing stage when the environment is acidic, such as in connection with a batter for a baked product. It is not suitable in processes where the mix is neutral or slightly basic and has the disadvantage of completely releasing the core component in the mix. Further, the process disclosed in U.S. Pat. No. 6,325,859 is not intended to protect the core ingredient through the mixing process, and to only allow release at the later point of heating during the final stages of preparation.

U.S. Pat. No. 6,863,917, issued Mar. 8, 2005 to Redding, Jr., et al., the disclosure of which is hereby incorporated by reference, is directed to a ready-to-use food product and method for preparing the same. The described product includes a batter, at least one leavening agent, and at least one oil. The oil separates the batter and leavening agent while in storage in a container, and agitation of the container causes the batter, leavening agent and oil to at least partially mix. According to one aspect of the invention disclosed in U.S. Pat. No. 6,863,917, the leavening base component is composed of either fully or partially coated or encapsulated sodium bicarbonate or other suitable base. The leavening agent can be encapsulated with either fats, waxes or hydrogenated vegetable oils that may breakdown in the acidic liquid batter and must therefore be separated by use of the oil. The product and method disclosed in U.S. Pat. No. 6,863,917 thus also suffers from the disadvantage that the leavening agent is released upon mixing rather than upon heating.

There are also some known encapsulation methods that rely upon temperature sensitive materials to control the release of ingredients in food products. For example, U.S. Pat. No. 5,536,519, issued on Jul. 16, 1996 to Ernst Graf and Johan P. Van Leersum, the disclosure of which is hereby incorporated by reference, discloses a method for preparing frozen flavor capsules as well as a method for incorporating these flavor capsules into low-fat frozen or refrigerated desserts. The capsules are prepared by first forming discrete composite capsules having a flavor encapsulated in an oil, and then freezing these capsules to solidify the oil and form discrete frozen solid flavor particles. Because the oil is essentially a liquid at ambient temperature, the oil liquefies in the mouth upon consumption, providing a balanced flavor release from the previously protected flavor capsule. One disadvantage of that technology is that the temperature range in which the encapsulation is effective limits its applicability to use in frozen foods.

Other compositions currently used in the industry for temperature controlled release of encapsulated ingredients use, for example, fully hydrogenated vegetable oils, triglycerides, and other esters such as monoesters and diesters of vegetable oils or sorbitan esters. The melting points of such compositions do not exceed 65° C., and this disadvantage has limited the utility of encapsulation via such materials to enhance the functional aspects of foods.

There thus exists a need for methods of encapsulating using encapsulation compositions that are not water soluble, that resist breakdown during mechanical abrasion, and that have melting points in excess of about 65° C.

### BRIEF SUMMARY OF THE INVENTION

The presently described technology generally relates to edible fatty acid ester compositions or matrixes prepared by blending a source of fatty acid or fatty acid ester with a polyhydroxy polyol to produce an ester or polyester of the polyhydroxy polyol with a melting point of the final composition of greater than about 65° C.

There are a number of uses for food grade high melt polyhydroxyl polyol esters or polyesters, including but not limited to fluid bed encapsulation shell materials, emulsifiers for food products, and personal care emulsifiers. Preferably, compositions made using the present technology can be incorporated into a food product as a structural component for encapsulation of a flavoring ingredient, leavening ingredient, or other desired food ingredient.

In at least one embodiment of the present technology, there is provided an edible composition containing a matrix of ingredients having at least one edible component that is an edible fatty ester with a melting point in excess of about 65° C., and at least one further second edible component contained within the matrix such that it is protected from the immediate environment.

In another embodiment of the presently described technology, there is provided a method of making an edible fatty ester composition comprising the steps of providing a first ingredient which is selected from fatty acids and fatty acid esters; providing a polyhydroxy polyol; and reacting the first ingredient with the polyhydroxy polyol to form an edible fatty acid ester composition.

In yet another embodiment of the present technology there is provided an edible fatty acid ester composition containing the reaction product of a fatty acid or fatty acid alkyl ester and a polyhydroxy polyol, and the fatty acid ester composition preferably has a melting point of at least about 65° C. or greater.

In still further embodiments there is provided one or more food products containing the edible compositions of the presently described technology made by the various method of manufacture described herein.

At least one advantage of embodiments of the presently described technology over compositions with lower melting points for encapsulation of functional food components is the ability to avoid release of the functional ingredient until temperatures exceed about 65° C. Although not wanting to be bound by any particular theory, it is believed that the embodiments of the presently described technology having melting points in excess of about 65° C. provide superior performance because the functional ingredient in the core of the encapsulate can withstand greater variations in processing temperatures, resist softening throughout a preliminary mixing and blending operation, and release the functional ingredient in later stages of preparation such as baking or microwave heating. For example, embodiments of the present technology are further believed to improve the organoleptic effect of leavening agents by preventing release during mixing so that leavening takes effect during the baking process.

### BRIEF DESCRIPTION OF SEVERAL VIEWS OF THE DRAWINGS

[Not Applicable]

### DETAILED DESCRIPTION OF THE INVENTION

The presently described technology relates to edible fatty acid ester compositions and matrixes, and methods of preparing the same. Edible fatty acid esters described herein may be used, for example, as an encapsulation material to avoid release of a functional ingredient within a food product until temperatures exceed about 65° C.

The presently described technology relates to edible fatty acid ester compositions and matrixes prepared by blending a source of fatty acid or fatty acid ester with a polyhydroxy polyol and reacting the two components under appropriate conditions to produce an ester or polyester of the polyhydroxy polyol with a melting point of the final composition of greater than about 65° C.

In at least one embodiment, an edible composition is provided that comprises a matrix wherein at least one of the components of the matrix is an edible fatty ester with a melting point in excess of about 65° C., and at least one second edible component that is contained within the matrix. Edible fatty acid ester matrixes of the present technology can be used, for example, to encapsulate components included in an ingredient mixture to prevent the components from becoming incorporated into the mixture until the encapsulate material melts or dissolves. Although not wanting to be bound by any particular theory, it is believed that embodiments of the presently described technology having melting points in excess of about 65° C. result in encapsulation that can be maintained during normal variations in processing temperatures, resist softening throughout preliminary mixing and blending operations, and prevent release of the functional ingredient within the encapsulate in later stages of preparation such as baking or microwave heating.

Another embodiment of the present technology provides a method of making an edible fatty ester composition comprising the steps of providing a first ingredient selected from the group consisting of fatty acids and fatty acid esters, providing a polyhydroxy polyol, and reacting the first ingredient with the polyhydroxy polyol to form an edible fatty acid ester composition. In at least one such method, a fatty acid or fatty acid ester is blended with a polyhydroxy polyol, and the blend is heated to sufficient temperature to accomplish esterification or transesterification. The preferred operating temperature range for direct esterification is from about 170° C. to about 250° C. More preferably, the operating temperature range for direct esterification is from about 200° C. to about 220° C. Most preferably, the operating temperature for direct esterification is about 210° C. Completion of the esterification reaction can be determined when the acid value is measured at less than about 8 mg KOH/g, and preferably at less than about 4 mg KOH/g.

Catalysts known to those of skill in the art can be used with the present technology to promote the reaction rate and reduce cycle time. Strong acid catalysts, however, will cause dehydration of the polyhydroxyl polyol, the consequence of which is reduction of the melting point of the final product. Whereas the use of dehydration processes to cyclize polyhydroxy polyols will result is a second polyol useful in the invention (i.e., isosorbide or isomannide), the physical dehydration of the polyhydroxy polyol in the presence of the fatty acid or fatty acid lower alkyl ester, i.e. during the esterification reaction, leads to unacceptable mixtures. The esterification reaction should preferably take place with an undisturbed polyhydroxy polyol and result in a product predominantly free of side products resulting from interaction of the catalyst and the polyhydroxy polyol.

Lipase catalysts are one example of acceptable catalysts for use with the present technology. When lipase catalysts are used, the preferred reaction temperature is between about 50° C. to about 60° C., and not the high temperatures used for direct condensation with fatty acids. Vacuum is preferably used to remove lower alkyl alcohols or water from this type of reaction. Solvents are also preferably used to facilitate the process as the catalyst deactivates at the temperatures required to melt the products. Acceptable solvents include, for example, dimethylsulfoxide (DMSO), ethanol or methanol. When dimethylsulfoxide is used, the product can be obtained by filtering off the catalyst and removing the solvent by vacuum distillation. When ethanol or methanol is used, the product and catalyst both form solid masses so the catalyst can be removed by filtration after the product is isolated and melted.

Once esterification is complete, edible fatty acid ester compositions of the present technology can be refined by filtering. The resulting composition may further be incorporated into a food product as a structural component for encapsulation of another food or flavoring ingredient. Encapsulation methods include, for example, fluid bed, spray congeal (freezing), prilling, and dry granulation. Ingredients that can be encapsulated include, for example, leavening agents, flavors, acidulents, antioxidants, coloring agents, oxidatively unstable fats and oils (e.g., omega-3 and omega-6), preservatives, and any water soluble food ingredient that one may wish to separate from the hydrated components of the food product, such as, for example, sugars or thickeners.

Another embodiment of the presently described technology encompasses an edible fatty acid ester composition comprising an ester or polyester of a polyhydroxy polyol with a melting point of greater than about 65° C. More preferably, edible fatty acid ester compositions of the present technology have a melting point of greater than about 72° C. Most preferably, edible fatty acid ester compositions of the present technology have a melting point of greater than about 78° C. Additionally, fatty acid ester compositions of the present technology preferably have a degree of substitution equal to or greater than 1 on the basis of available hydroxyl functionality.

Yet another embodiment of the presently described technology comprises an encapsulated product utilizing an edible fatty acid ester composition comprising an ester or polyester of a polyhydroxy polyol as one of the structural components, preferably as the shell component. The ingredient to be encapsulated can be mixed with the melted ester or polyester to form the encapsulate matrix and then be formed into small spheres. Small spheres prepared in this fashion are known in the art as microcapsules and processes to manufacture such microcapsules are known as microencapsulation processes. Microencapsulation processes to make such small spheres include, for example, spraying into cold air or into a cold immiscible fluid.

In addition to forming a mixture of ingredients in a liquid phase and then forming microcapsules from the mixture of ingredients, compositions of the presently described technology can be used to coat or enrobe preformed particles composed of ingredients to be encapsulated. In such cases the microcapsule is physically two phases, the center or core phase and an outer or shell phase. Alternatively, a melted mixture of ingredients can be sprayed onto a second solid ingredient such as starch or flour in a dry granulation process, to form the matrix.

No matter which technique is used to form the microcapsule, compositions of the presently described technology all consist of mixtures of ingredients, defined as the matrix of ingredients, and as is apparent to anyone skilled in the art, the function of the ester or polyester is to act as the shell component of said matrix to provide protection to the other ingredients contained within the matrix from damage caused by environmental conditions.

The fatty acids making up the esters in compositions of the present technology preferably contain about 4 to about 22 carbons. More preferably, the fatty acids contain about 16 to about 22 carbons. Most preferably, the fatty acids contain about 18 to about 22 carbons. Examples of fatty acids that can be used with the present technology include, for example, lauric, myristic, palmitic, stearic and behenic fatty acids. Preferably, saturated fatty acids are used. Additionally, it should be understood by those skilled in the art that any fatty acid ester as a reactant may be utilized in the spirit and scope of the presently described technology. For example, methyl esters, ethyl esters and glycol esters may be utilized.

Polyhydroxy polyols suitable for use in the present technology can be selected, for example, from the class of compounds known as sugars. Moreover, suitable polyhydroxyl polyols can be selected from the group of sugars known as non-reducing sugars. Preferable non-reducing sugars include, but are not limited to, glucose and sucrose. As another example, suitable polyhydroxyl polyols can be selected from the group of sugars known as fully reduced sugars. Preferable fully reduced sugars include, but are not limited to, erythritol, xylitol, sorbitol, and mannitol.

Polyhydroxy polyols suitable for use in the present technology can also be dehydrated prior to interesterification. Preferably, the dehydrated polyhydroxy polyol is anhydro-sorbitol, anhydro-mannitol, or anhydro-erythritol. Most preferably the dehydrated polyhydroxy polyol is isosorbide or isomannide.

Polyhydroxy polyols of the present technology can be directly esterified with a fatty acid or transesterified with a lower-alkyl ester of the fatty acid. A catalyst is preferably used to promote esterification or transesterification. Suitable catalysts, for example, include organic acids, organic bases, inorganic acids and inorganic bases. Preferably, catalysts should be sufficiently strong to promote esterification or transesterification but insufficiently strong so as to promote anhydrization of the polyhydroxy polyol.

Polyhydroxy polyols suitable for use in the present technology can also be interesterified with a vegetable oil or fully hydrogenated vegetable oil. Preferably, a base catalyst is used to promote interesterification. More preferably, the catalyst used to promote interesterification is an enzymatic catalyst compatible with food products, such as a lipase. Additionally, when polyhydroxy polyols of the present technology are interesterified with a vegetable oil or fully hydrogenated vegetable oil, the reaction can be carried out in the presence of a solvent. Suitable solvents include, for example, methanol, ethanol, hexane and dimethylsulfoxide.

All documents, e.g., patents and journal articles, cited above and/or below, are hereby incorporated by reference in their entirety. One skilled in the art will recognize that modifications may be made in the presently described technology without deviating from the spirit or scope of the invention. The presently described technology is also illustrated by the following examples, which are not to be construed as limiting the invention or scope of the specific procedures or compositions described herein. In the following Examples, all amounts are stated as weight unless indicated otherwise. Additionally, all levels and ranges, temperatures, results, etc., used and/or described herein are approximations unless otherwise specified.

Examples 1-5 below show the melting points for various edible fatty acid ester compositions of the present technology. Example 6 illustrates that the strength of the catalyst can affect the melting point of the edible fatty acid ester composition.

### Example 1

### Reaction of Erythritol and Stearic Acid

159.34 g of stearic acid was blended with 40.66 g of erythritol and was esterified by heating the blend to 210° C. and holding the blend at that temperature until the acid value was reduced to below 8 mg KOH/g. Water generated from the reaction was collected in a Dean-Stark trap. After completion of the esterification, the product was cooled to 90° C. and pumped through a polishing filter. The melting point of the final product was 80° C.

### Example 2

### Reaction of Erythritol and Stearic Acid Using a Base Catalyst

112.17 g of stearic acid was blended with 40.66 g of erythritol. The blend was treated with 2.01 g of potassium carbonate (1% by wt.) and heated to 190° C. Water generated from the reaction was collected in a Dean-Stark trap. After completion of the esterification, the product was cooled to 90° C. and pumped through a polishing filter. The melting point of the final product was 82° C.

### Example 3

### Reaction of Isosorbide and Behenic Acid

466.25 g of behenic acid was blended with 100.01 g of isosorbide. The blend was esterified by heating to 245° C. and holding for 16 hours. Water generated from the reaction was collected in a Dean-Stark trap. After completion of the esterification, the product was cooled to 90° C. and pumped through a polishing filter. The melting point of the final product was 80° C.

### Example 4

### Reaction of Erythritol and Fully Hydrogenated Soybean Oil

312.8 g of fully hydrogenated soybean oil was blended with 87.2 g of erythritol. The blend was treated with 3.9 g (1% by weight) of sodium hydroxide (NaOH) at 150° C. The reaction temperature was increased ten degrees every hour for 3 hours and then held at 180° C. for 4 hours. After completion of the interesterification reaction, the catalyst was neutralized with 5.8 g of 85% phosphoric acid. The product was cooled to 90° C. and pumped through a polishing filter. The melting point of the final product was 68° C.

### Example 5

### Degree of Substitution of Erythritol

This example shows that the degree of substitution for erythritol esters will affect the melting point. The following procedure was followed for each of the rows in Table 1 below, with the only difference being the degree of substitution. Stearic acid was blended with erythritol and was esterified by heating the blend to 210° C. and holding the blend at that temperature until the acid value was reduced to below 8 mg KOH/g. Water generated from the reaction was collected in a Dean-Stark trap. After completion of the esterification, the product was cooled to 90° C. and pumped through a polishing filter. The melting points of the final products are set forth in Table 1 below.

TABLE 1

| Degree of Substitution | MP (° C.) |
|---|---|
| 1.0 | 78.5 |
| 2.0 | 70.0 |
| 3.0 | 67.0 |

### Example 6

### Reaction of Erythritol and Stearic Acid Using Too Strong an Acid Catalyst

160.12 g of stearic acid was blended with 39.98 g of erythritol. The blend was treated with 0.51 g (0.25% by wt.) para-Toluenesulfonic acid and heated to 150° C. The reaction was held at 150° C. for 7 hours. Water generated from the reaction was collected in a Dean-Stark trap. The amount of water collected, was equal to one and a half equivalents, or 50% more water than theory; this is an indication that anhydrization of the polyhydroxy polyol took place. Once the reaction was complete, the catalyst was neutralized with 5.8 g of 50% NaOH. The product was cooled to 90° C. and pumped through a polishing filter. The melting point of the final product was 64° C. The hydroxyl value for this product was measured at 64.5 (theoretical hydroxyl value is 150-180), confirming that anhydrization took place.

The presently described technology and the manner and process of making and using it, are now described in such full, clear, concise and exact terms as to enable one of ordinary skill in the art to which the present technology pertains, to make and use the same. It should be understood that the foregoing describes some embodiments and advantages of the invention and that modifications may be made therein without departing from the spirit and scope of the presently described technology as set forth in the claims. Moreover, the invention has been described with reference to preferred and alternate embodiments. Modifications and alterations will occur to others upon the reading and understanding of the specification. It is intended to include all such modifications and alterations insofar as they come within the scope of the appended claims or equivalents thereof. To particularly point out and distinctly claim the subject matter regarded as the invention, the following claims conclude this specification.

What is claimed is:

1. An edible composition comprising a matrix wherein at least one of the components of the matrix is an edible fatty ester with a melting point in excess of about 65° C., and at least one second edible component that is contained within the matrix.

2. A food product comprising the edible composition of claim 1.

3. A method of making an edible fatty ester composition comprising the steps of:
providing a first ingredient selected from the group consisting of fatty acids and fatty acid esters;
providing a polyhydroxy polyol; and
reacting the first ingredient with the polyhydroxy polyol to form an edible fatty acid ester composition.

4. An edible fatty acid ester composition prepared in accordance with the method of claim 3.

5. An encapsulated product comprising an edible fatty acid ester composition of claim 4.

6. An encapsulated product comprising an edible fatty acid ester composition of claim 4 as a shell structural component, and further comprising an additional encapsulation component.

7. A microcapsule containing an edible fatty acid ester composition prepared in accordance with the method of claim 3.

8. The method of claim 3, wherein the first ingredient is a fatty acid and wherein during the reacting step the polyhydroxy polyol is esterified with the fatty acid.

9. The method of claim 8, wherein the polyhydroxy polyol is esterified with the fatty acid at a temperature from about 170° C. to about 250° C.

10. The method of claim 8, wherein the polyhydroxy polyol is esterified with the fatty acid at a temperature from about 200° C. to about 220° C.

11. The method of claim 8, wherein the polyhydroxy polyol is esterified with the fatty acid at a temperature of about 210° C.

12. The method of claim 3, wherein the first ingredient is a lower alkyl ester of a fatty acid and wherein during the reacting step the polyhydroxy polyol is transesterified with the lower alkyl ester of a fatty acid.

13. The method of claim 3, wherein the polyhydroxy polyol is interesterified with a vegetable oil or an animal fat.

14. The method of claim 13, wherein the vegetable oil is a fully hydrogenated vegetable oil.

15. The method of claim 3, wherein a catalyst is used to promote the reaction.

16. The method of claim 15, wherein the catalyst is a member selected from the group consisting of organic acids, organic bases, inorganic acids and inorganic bases.

17. The method of claim 15, wherein the catalyst is a member selected from the group of enzymatic catalysts compatible with food products.

18. The method of claim 17, wherein the enzymatic catalyst is a lipase.

19. The encapsulated product of claim 6, wherein the encapsulated component is a flavor or flavor-enhancing agent.

20. The encapsulated product of claim 6, wherein the encapsulated component is a leavening agent.

21. The encapsulated product of claim 6, wherein the encapsulated component is an omega-3 or an omega-6 fatty acid containing edible fat or oil.

22. A food product of claim 21, wherein the omega-3 fatty acid containing oil is fish oil.

23. A food product of claim 22, wherein the omega-3 fatty acid containing oil is a member selected from the group consisting of salmon oil, tuna oil, and menhaden oil.

24. The encapsulated product of claim 6, wherein the encapsulated component is an acidulent.

25. The encapsulated product of claim 24, wherein the acidulent is a member selected from the group consisting of citric acid, ascorbic acid and conjugated linoleic acid.

26. The encapsulated product of claim 6, wherein the encapsulated component is a member selected from the group consisting of conjugated linoleic acid, an ester of conjugated linoleic acid, and a salt of conjugated linoleic acid.

27. The encapsulated product of claim 26, wherein the ester of conjugated linoleic acid is a member selected from the group consisting of monoglycerides containing conjugated linoleic acid, diglyceride containing conjugated linoleic acid, triglyceride containing conjugated linoleic acid, derivatives thereof, and mixtures thereof.

28. The encapsulated product of claim 26, wherein the ester of conjugated linoleic acid is a lower alkyl ester.

29. The encapsulated product of claim 28, wherein the lower alkyl ester of conjugated linoleic acid is methyl or ethyl ester.

30. The encapsulated product of claim 6, wherein the encapsulated component is an approved food colorant.

31. The encapsulated product of claim 6, wherein the encapsulated component is an anti-oxidant.

32. The encapsulated product of claim 31, wherein the anti-oxidant is a member selected from the group consisting of vitamin E, green tea extract, grape extract, ascorbyl palmitate, propyl galate, rosemary oil, BHA and BHT.

33. The encapsulated product of claim 6, wherein the encapsulated component is a nutritional supplement.

34. The encapsulated product of claim 33, wherein the nutritional supplement is a member selected from the group consisting of lutein, choline and probiotics.

35. The encapsulated product of claim 6, wherein the encapsulated component is a vitamin.

36. The encapsulated product of claim 35, wherein the vitamin is a member selected from the group consisting of vitamin A, vitamin B, vitamin C and folic acid.

37. The encapsulated product of claim 6, wherein the encapsulated component is a mineral.

38. The encapsulated product of claim 37, wherein the mineral is a member selected from the group consisting of iron, calcium, zinc, magnesium or potassium.

39. An edible fatty acid ester composition comprising the reaction product of a fatty acid or fatty acid alkyl ester and a polyhydroxy polyol, the fatty acid ester composition having a melting point of at least about 65° C. or greater.

40. An edible fatty acid ester composition of claim 39, having a melting point of at least about 72° C.

41. An edible fatty acid ester composition of claim 39, having a melting point of at least about 78° C.

42. An edible fatty acid ester composition of claim 39, wherein the fatty acids making up the ester each contain from about 4 to about 22 carbon atoms.

43. An edible fatty acid ester composition of claim 42, wherein the fatty acids making up the ester each contain about 16 to about 22 carbon atoms.

44. An edible fatty acid ester composition of claim 43, wherein the fatty acids making up the ester each contain about 18 to about 22 carbon atoms.

45. An edible fatty acid ester composition of claim 39, wherein the polyhydroxy polyol is a sugar.

46. An edible fatty acid ester composition of claim 45, wherein the sugar is a non-reducing sugar.

47. An edible fatty acid ester composition of claim 45, wherein the sugar is a member selected from the group consisting of glucose and sucrose.

48. An edible fatty acid ester composition of claim 39, wherein the polyhydroxy polyol is a fully reduced sugar.

49. An edible fatty acid ester composition of claim 48, wherein the fully reduced sugar is a member selected from the group consisting of erythritol, sorbitol, mannitol and xylitol.

50. An edible fatty acid ester composition of claim 39, wherein the polyhydroxy polyol is dehydrated.

51. An edible fatty acid ester composition of claim 50, wherein the dehydrated polyhydroxy polyol is a member selected from the group consisting of anhydro-sorbitol, anhydro-mannitol and anhydro-erythritol.

52. An edible fatty acid ester composition of claim 50, wherein the dehydrated polyhydroxy polyol is a member selected from the group consisting of isosorbide and isomannide.
